(19) United States
(12) Patent Application Publication
(10) Pub. No.: US 2014/0346977 A1
(43) Pub. Date: Nov. 27, 2014

(54) CONTROLLER FOR A FLUORESCENT LAMP

(71) Applicant: EASY SOLUTION HOLDINGS LIMITED, ROAD TOWN, TORTOLA (VG)

(72) Inventor: Kwok Yan Michael Lau, Kowloon (HK)

(73) Assignee: EASY SOLUTION HOLDINGS LIMITED, Road Town, Tortola (VG)

(21) Appl. No.: 14/353,222

(22) PCT Filed: Oct. 16, 2012
(86) PCT No.: PCT/EP2012/004326

§ 371 Date: Apr. 21, 2014

(30) Foreign Application Priority Data
Oct. 25, 2011 (EP) 11008551.1

(51) Int. Cl. H05B 41/04

(52) U.S. Cl. CPC H05B 41/04
USPC 315/362

(57) ABSTRACT

A controller for a fluorescent lamp comprises a toggle arrangement adapted to turn the lamp on, in response to a user performing an on-off-on power toggle, wherein the on-off-on power toggle comprises a first on-period, during which the controller prevents the lamp from being turned on.

### TECHNICAL FIELD

The device and method described herein relate to controllers for fluorescent lamp fixtures.

### BACKGROUND

Fluorescent lamps are commonly used as a source of artificial light within homes, office spaces, and other places in which indoor or outdoor lighting is required. Fluorescent lamps function by using electricity to excite mercury vapour within a glass tube coated with phosphorous or other fluorescent material, producing a gas-discharge that results in visible light. Fluorescent lamps have been shown to have higher energy efficiency than incandescent lamps.

However, unlike incandescent lights, fluorescent light fixtures cannot be connected to dimmer switches, as it is impossible to sustain an arc in the fluorescent tube at low power levels. Therefore, to achieve a dimming effect in a fluorescent lamp, a compatible dimming ballast must be installed. Such an installation can be expensive and laborious, or can even require the replacement of the fluorescent lamp in its entirety. Thus, providing for a fluorescent lamp fixture that has a dimming function requires expensive and time-consuming reinstallation of the ballast of an existing fluorescent lamp and ballast system, or else replacement of the entire lamp.

### SUMMARY

A controller for a fluorescent lamp is disclosed, which addresses at least one of the above described problems of the prior art.

An embodiment provides a controller for a fluorescent lamp comprising a toggle arrangement which is adapted to turn the fluorescent lamp on in response to a user performing an on-off-on power toggle. The on-off-on power toggle comprises a first on-period, during which the controller prevents the lamp from being turned on.

By using this controller in a lighting fixture comprising a plurality of fluorescent lamps, a dimming function can be effected. More specifically, the plurality of lamps may be divided into a first group of lamps which are each fitted with such a controller, and a second group of lamps without such controllers. A “brightening” effect can be achieved as follows: in response to a user initially turning the power on, the second group of lamps which are not fitted with controllers will turn on, while the remaining lamps from the first group will remain off. When a user performs an additional off-on power toggle, then during the off-period, the second group of lamps will turn off (and the first group of lamps will remain off). During the following on-period of the off-on toggle, both the first and second groups of lamps will turn on. In this way, extensive refitting of the fluorescent lamps can be avoided, while enabling the lighting fixture to provide adjustable brightness. The means for turning on only a subset of lamps within a system containing a plurality of lamps can be easily and cost-effectively provided.

In an embodiment of the controller, the off-period of the on-off-power toggle is limited by a timer. This allows the dimmer system to be reset to its original stage if a is user simply wishes to turn the lights off, rather than to brighten the lights.

The controller is suitable for use in a unit comprising the controller connected to a fluorescent lamp, the unit being connected to a user-operable power switch. The toggle arrangement may comprise the timer, which may be activated in response to the power switch being opened. The toggle arrangement may also comprise a main switch which is adapted to close, causing the lamp to be lit, in response to the power switch being closed while the timer is active.

By providing for the timer and main switch within the toggle arrangement, the fluorescent lamp may be turned on, only if the power is already on, and then toggled off for a short period, corresponding to the period of the timer. In a lighting fixture comprising a plurality of lamps, some of which have the controller applied and some of which do not, this allows a user to turn on the lamps which are not fitted with the controller initially, and to subsequently turn all of the lamps on by quickly toggling the power off and than on again.

The controller is suitable for use in a unit comprising the controller connected to a fluorescent lamp, the unit being connected to a user-operable power switch. The toggle arrangement may comprise an auxiliary switch which is adapted to close in response to the power switch being initially closed. Further, the toggle arrangement may comprise the timer, which may be activated in response to the power switch being opened while the auxiliary switch is in a closed position. Finally, the toggle arrangement may comprise a main switch which is closed while the timer is active.

The lamp may be turned on in response to the power switch being closed while the main switch is in a closed position. The main switch may remain closed while the lamp is on.

The controller may further comprise a timing capacitor, which is charged when the auxiliary switch is in a closed position. The charge on the timing capacitor can cause the timer to be active, and to hold the main switch closed. In a preferred embodiment, the timing capacitor can be connected to ground via a discharge resistor, and the capacitance and resistance values determine an active period of the timer.

In some embodiments, the timer remains active for a period of at least 0.01 seconds.

In some embodiments, the timer remains active for a period of less than 10 seconds.

The active period of the timer determines the off period of the on-off-on power toggle, during which the power may be turned back on and cause the lamp which is connected to the controller to be lit. After the off-period which is determined by the timer has elapsed, the controller will return to its initial state. In this initial state, closing the power switch does not turn on the lamp which is connected to the controller.

A fluorescent lighting system comprising any of the controllers described above is also disclosed. The lighting system further comprises a first fluorescent lamp, a second fluorescent lamp, and a user-operable power switch. The controller and first lamp are connected to form a unit, which is connected in parallel to the second lamp. The unit and the second lamp are connected to the power switch, such that the second fluorescent lamp is lit in response to the power switch being closed.

This fluorescent lighting system can be used to produce a state in which both lamps are off, as well as a “dim” state in which only the second lamp is on, and a “bright” state in which both lamps are on. By applying the controller to the first lamp, the first lamp only turns on in response to the power being turned on, then off (for a limited period), then on. The second lamp is on any time that the power is on. In this way, an initial “dim” state is achieved by turning the power on, at which time only the second lamp is on, and a second “bright” state is achieved by toggling the power off then on, at which time both the first and second lamps will be lit. In an environment where there is sunlight, the system can be used to reduce energy usage during the day (with the “dim” state), while providing sufficient light (with the “bright” state) at night.

Finally, a method for turning a fluorescent lamp on is disclosed. The fluorescent lamp is connected in series to a controller, which in turn is connected in series to a user-operable power switch. The method comprises the steps of: closing the power switch for a first period, during which the controller prevents the lamp from turning on; opening the power switch for a second period; and closing the power switch for a third period, during which the lamp is on. The second period may be limited by a timer.

### BRIEF DESCRIPTION OF THE DRAWINGS

Preferred embodiments will now be described with reference to the accompanying drawings, in which:

FIG. 1 is a schematic view of a fluorescent lamp fitted with a controller, when power is an off state;

FIG. 2 is a schematic of the lamp and controller of FIG. 1, in which power has initially been turned on;

FIG. 3 is a schematic of the controller of FIG. 1, in which power has been toggled off for a short period of time, and the timer remains active;

FIG. 4 is a schematic of the controller and lamp of FIG. 1, in which power has been turned back on, thus causing the lamp to be lit;

FIG. 5 is a circuit diagram, illustrating one possible implementation of the controller shown in FIGS. 1 to 4; and

FIG. 6 is a schematic of the controller in a fluorescent lighting system comprising two fluorescent lamps.

### DETAILED DESCRIPTION

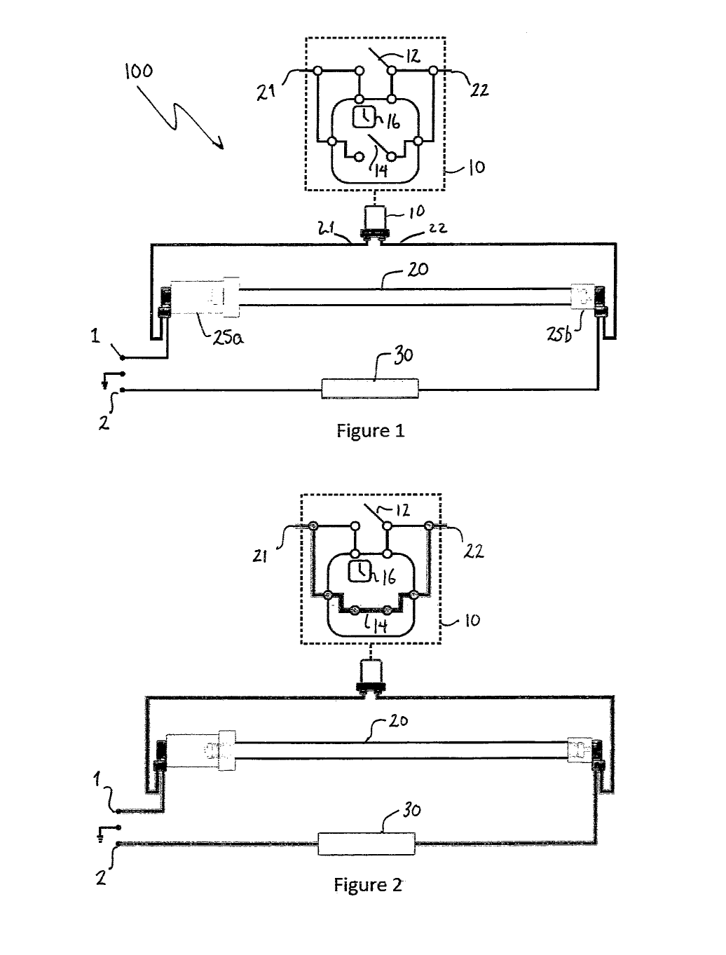

FIG. 1 shows a controller 10 connected to a fluorescent lamp 20 and ballast 30, which together form a unit 100. The lamp 20 and ballast 30 are connected to positive and negative terminals 1, 2 of a power source. The lamp 20 may be fitted with an energy-saving starter circuit 25a, 25b, as described in patent document WO 0021342 (Apr. 13, 2000). However, the fluorescent lamp may also be provided without any starter circuit 25a, 25b, as shown in FIG. 1. The terminals 21, 22 of lamp 20 are connected to the inputs of controller 10.

The controller 10 includes a toggle arrangement comprising an auxiliary switch 12, a main switch 14 and a timer 16. The auxiliary switch 12 and the main switch 14 are biased to be open when power is not applied. FIG. 1 shows the controller 10 in an initial, lasting configuration, in which power has not been applied to positive and negative terminals 1, 2.

FIG. 2 shows the configuration of controller 10 after which power has initially been applied to the terminals 1, 2. As shown in FIG. 2, the application of power causes auxiliary switch 14 to close, thus circumventing the flow of power around main switch 12, and causing the lamp to remain unlit.

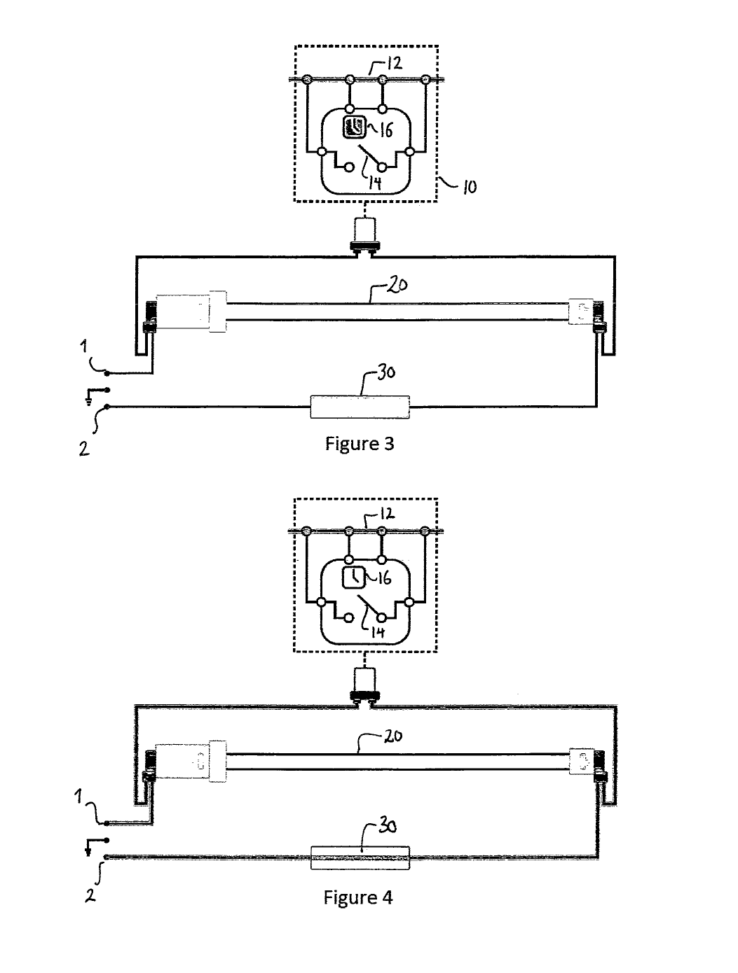

FIG. 3 shows the controller 10 in a state in which power has been removed from the terminals 1, 2 following a period during which power was applied, as shown in FIG. 2. In FIG. 3 it can be seen that auxiliary switch 14 is open, and that timer 16 is active, causing the main switch 12 to be held closed. While the timer remains active, if power is again applied to the terminals 1, 2, then the controller will proceed to the state shown in FIG. 4. However, if the timer expires before power is applied to the terminal, the state of the controller 10 will return to the state shown in FIG. 1, with both main switch 12 and auxiliary switch 14 in an open position.

FIG. 4 shows the final state of the controller 10, in which power has been applied to terminals 1, 2 and the main switch 12 remains closed, thus causing the lamp 20 to be lit. When power is removed from the terminals 1, 2, the main switch 12 will open and the controller 10 will return to the state shown in FIG. 1.

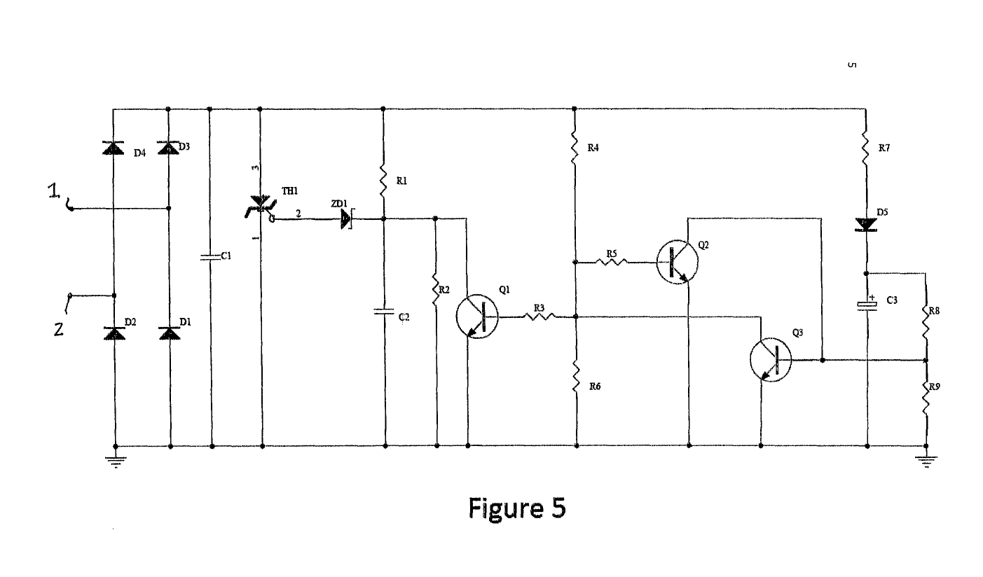

FIG. 5 shows a circuit diagram which may be used to implement the schematic controller shown in FIGS. 1 to 4. Some elements of the circuit are: transistor elements Q1, Q2 and Q3; a timing capacitor C3 in parallel to timing resistors R8 and R9; as well as thyristor TH1 coupled to a Zener diode ZD1 for powering the fluorescent lamp. In an inactive state corresponding to the state shown in FIG. 1, the transistors Q1, Q2 and Q3 of FIG. 5 are all open (i.e., not transmitting from source to sink).

When power is initially applied, as shown in the state illustrated in the schematic in FIG. 2, a current flows through the resistors R3, R4, R5 causing a charge to accumulate on the gates of transistors Q1, Q2, thus causing these gates to open. The opening of transistor Q1 causes the resistor R1 to be shorted to ground, thus causing the Zener diode ZD1 to be shorted to ground. In other words, the “main switch” embodied in thyristor TH1 remains open. Furthermore, the opening of transistor Q2 causes any charge on the negative side of timing capacitor C3 to be shorted to ground, thus preventing the “timing transistor” Q3 from becoming active. In the initial state corresponding to FIG. 2, charge accumulates on timing capacitor C3.

When power is removed from power terminals 1, 2, transistors Q1 and Q2 return to an open state, while the charge stored on capacitor C3 flows through resistor R8, causing “timing transistor” Q3 to close. The timer thus remains active until the charge on capacitor C3 has substantially drained to ground via resistor R9.

If power is reapplied to terminals 1, 2 before the charge on timing capacitor C3 has been fully drained, then the charge on the gate of “timing transistor” Q3 will cause the resistor R4 to be tied to ground, thus causing the transistors Q1, Q2 to remain open. With transistor Q1 being open, the voltage of the Zener diode ZD1 is split according to the resistor values R1, R2. When the Zener voltage is exceeded, thyristor TH1 is opened, causing the lamp 20 be lit. Moreover, with transistor Q2 being in an open state, the charge on the gate of transistor Q3 is not drained to ground, and therefore transistor Q3 remains active.

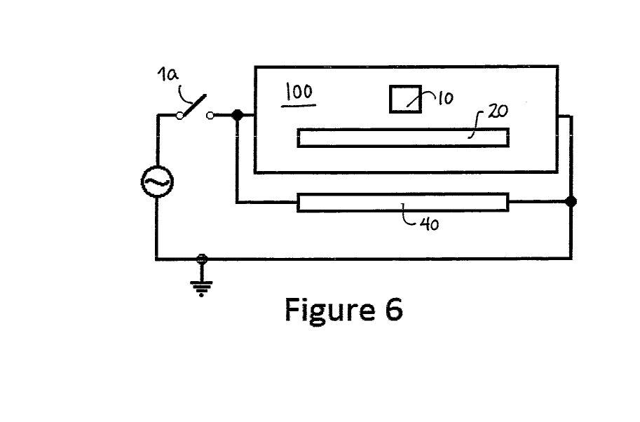

FIG. 6 shows a lighting system comprising a unit 100 which includes the controller 10 and first lamp 20. The unit 100 is connected in parallel to a second fluorescent lamp 40. Both the unit 100 and the second lamp 40 are connected to a power switch 1a.

When the power switch la is initially open, then both first and second lamps 20, 40 are off. When the power switch la is first closed, a dim state is produced as follows: the second lamp 40 turns on, while the controller 10 prevents the first lamp 20 from turning on. Next, when the power switch is turned off, both lamps 20, 40 are off, and the timer 16 of the controller 10 is activated. If the switch la is closed again while the timer 16 of controller 10 remains active, then a bright state is produced, as both lamps 20, 40 turn on. In an environment where there is sunlight, this system can be used to reduce energy usage during the day (with the dim state), while providing sufficient light (with the bright state) at night, by simply toggling the switch 1a to progress from the dim state to the bright state.

It will be appreciated that various modifications may be made to the embodiment described herein without departing from the claimed subject matter. The controller can be adapted for use with incandescent light bulbs. The main switch 12 can be triggered to close either upon opening of the auxiliary switch 14, or upon application of power to terminals 1,2 while timer 16 remains active.

The switches 12, 14 and timer 16 shown in FIGS. 1 to 4 may be implemented with various circuit configurations besides the one shown in FIG. 5. Alternatively, the values of the circuit elements shown in the schematic in FIG. 5 may be adjusted so as to provide desired behaviours, for example to adjust the period of the timer.

In other embodiments, two or more controllers may be provided hierarchically or in a “cascade”, in a system with three or more lamps, to provide more than two lighting states. For example, a system with three lamps could be provided, in which there are three states: a “dim” state in which only one lamp is on, a “medium” state in which two lamps are on, and a “bright” state in which all three lamps are on. The dimming gradation could also be extended to include four or more states, corresponding to the number of lamps.

Alternatively or additionally, two or more controllers may be connected in series or “stacked” so as to cause a single lamp turn on only after multiple cycles of the on-off-on toggle. For example, a stacked controller could be provided which causes a fluorescent lamp to be lit in response to an on-off-on-off-on power toggle (two off-on power toggles). The timers limiting the first and second off-periods could have the same time value, or different time values.

1. A controller (10) for a fluorescent lamp (20) comprising:
a toggle arrangement (12,16) adapted to turn the lamp (10) on, in response to a user performing an on-off-on power toggle,
wherein the on-off-on power toggle comprises a first on-period, during which the controller (10) prevents the lamp (20) from being turned on
wherein the controller (10) has two terminals, and
wherein two terminals (21, 22) of the lamp (20), which are provided at opposite ends of the lamp (20), are connected to the terminals of the controller (10).

2. The controller of claim 1, wherein the on-off-on power toggle comprises an off-period, which is limited by a timer (16).

3. The controller (10) of claim 2, suitable for use in a unit (100) comprising the controller (10) connected to a fluorescent lamp (20), the unit (100) being connected to a user-operable power switch (1, 2), wherein the toggle arrangement (12,16) comprises:
the timer (16), which is activated in response to the power switch (1, 2) being opened, and
a main switch (12) which is adapted to close, causing the lamp (20) to turn on, in response to the power switch (1, 2) being closed while the timer (16) is active.

4. The controller (10) of claim 2, suitable for use in a unit (100) comprising the controller (10) connected to a fluorescent lamp (20), the unit (100) being connected to a user-operable power switch (1, 2), wherein the toggle arrangement (12,14,16) comprises:
an auxiliary switch (14) which is adapted to close in response to the power switch being initially closed;
the timer (16), which is activated in response to the power switch being opened while the auxiliary switch (14) is in a closed position; and
a main switch (12) which is closed while the timer (16) is active,
wherein the lamp (20) is turned on in response to the power switch (1,2) being closed while the main switch (12) is in a closed position, and
wherein the main switch (12) remains closed while the lamp (20) is on.

5. The controller of claim 4, wherein a timing capacitor (C3) is charged when the auxiliary switch (14) is in a closed position, such that when the auxiliary switch (14) is opened, a charge on the timing capacitor (C3) causes the timer (16) to be active, and causes the main switch (12) to be closed.

6. The controller of claim 5, wherein the timing capacitor (C3) is connected to ground via a discharge resistor (R9), and the timing capacitor (C3) and resistor (R9) determine an active period of the timer.

7. The controller of claim 2, wherein the timer (16) remains active for a period of at least 0.01 seconds, and/or wherein the timer (16) remains active for a period of less than 10 seconds.

8. A fluorescent lighting system comprising the controller (10) of the preceding claims, and further comprising:
a first fluorescent lamp (20) and a second fluorescent lamp (40), and
a user-operable power switch (1a),
wherein the controller (10) and first lamp (20) are connected to form a unit (100), and
wherein the unit (100) is connected in parallel to the second lamp (40), and
wherein the unit (100) and second lamp (40) are connected to the power switch (1a), such that the second fluorescent lamp is on while the power switch (1a) is closed.

9-10. (canceled)

11. The controller of claim 3, wherein the timer (16) remains active for a period of at least 0.01 seconds, and/or wherein the timer (16) remains active for a period of less than 10 seconds.

12. The controller of claim 4, wherein the timer (16) remains active for a period of at least 0.01 seconds, and/or wherein the timer (16) remains active for a period of less than 10 seconds.

13. The controller of claim 5 wherein the timer (16) remains active for a period of at least 0.01 seconds, and/or wherein the timer (16) remains active for a period of less than 10 seconds.

14. The controller of claim 6, wherein the timer (16) remains active for a period of at least 0.01 seconds, and/or wherein the timer (16) remains active for a period of less than 10 seconds.
